(19) United States
(12) Patent Application Publication
(10) Pub. No.: US 2023/0346167 A1
(43) Pub. Date: Nov. 2, 2023

(54) BLENDING SYSTEMS

(71) Applicants: Sensio Inc., New York, NY (US); Sensio Inc., Montréal (CA)

(72) Inventors: Jorge B. Garcia, Rogers, AR (US); Keith Bilodeau, Plantsville, CT (US); Tristan Mckeever, Montreal (CA)

(21) Appl. No.: 18/131,248

(22) Filed: Apr. 5, 2023

Related U.S. Application Data
(60) Provisional application No. 63/327,648, filed on Apr. 5, 2022.

(51) Int. Cl. A47J 43/08

(52) U.S. Cl. CPC A47J 43/085

(57) ABSTRACT

In accordance with at least one aspect of this disclosure, a system includes, a container configured to hold foodstuffs and a base configured to be operatively coupled to the container. In embodiments, the base includes, a first set of blades having a first shape configured and adapted to process foodstuffs within the container, a second set of blades operatively connected to the first set of blades having a second shape configured and adapted to blend the foodstuffs within the container, and a controller operatively connected to control a motor to drive the first set of blades and the second set of blades about a rotational axis. The controller is configured to automatically switch between a first speed and a second speed based on a predefined program selected by a user. In embodiments, the first speed is slower than the second speed.

### CROSS-REFERENCE TO RELATED APPLICATIONS

This application claims priority to and the benefit of U.S. Provisional Application No. 63/327,648, filed Apr. 5, 2022, the entire contents of which are herein incorporated by reference in their entirety.

### TECHNICAL FIELD

The present disclosure relates to blending systems.

### BACKGROUND

Conventional blenders typically include a single set of upwards pointing blades for mixing foodstuffs within the attached container. These blades can run at different speeds, but require user intervention to change the speeds. Moreover, the blades and speeds that are user selectable on a conventional blender may not be suitable for the food preparation that is desired by the user, which could leave behind unblended ingredients and can leave the mixture with an undesirable consistency or texture for the desired preparation, for example.

The conventional techniques for blending foodstuffs have been considered satisfactory for their intended purpose. However, there is an ever present need for improved systems and methods for blending foodstuffs to achieve more consistent results. This disclosure provides a solution for this need.

### SUMMARY

In accordance with at least one aspect of this disclosure, a system includes, a container configured to hold foodstuffs and a base configured to be operatively coupled to the container. In embodiments, the base includes, two or more sets of blades, including a first set of blades having a first shape configured and adapted to process foodstuffs within the container, a second set of blades operatively connected to the first set of blades having a second shape configured and adapted to blend the foodstuffs within the container. The base also includes a controller operatively connected to control a motor to drive the first set of blades and the second set of blades about a rotational axis. The controller is configured to automatically switch between a first speed and a second speed based on a predefined program selected by a user. In embodiments, the first speed is slower than the second speed.

In embodiments, the controller can include a memory, the memory configured to store the predefined program. In embodiments, the predefined program can include, a respective type of foodstuff, a respective type of preparation for a the respective type of foodstuff, and a respective timing sequence for the respective type of preparation. The respective timing sequence can include a first time interval for operation of the blades at the first speed to process the foodstuffs (e.g., as a food processor), a second time interval for operation of the blades at the second speed subsequent to completion of the first time interval to blend the foodstuffs (e.g., as a blender or mixer), and a third time interval for operation of the blades at either the first speed, the second speed, or a third speed subsequent to completion of the second time interval to complete preparation of the foodstuffs. In embodiments, the controller can be configured to control the motor to cycle the blades through a series of the first time interval, the second time interval, and the third time interval based on the predefined program, wherein an order of the first time interval, the second time interval, and the third time interval in the timing sequence and a number of cycles is defined by the predefined program. Processing the foodstuff can include at least one of: crushing, chopping relatively large pieces of foodstuff and blending the foodstuffs can include at least one of: stirring, pureeing, mixing relatively small pieces of foodstuffs (e.g., smaller than the large pieces).

In embodiments, the base can include a user interface having one or more user selectable buttons corresponding to a respective predefined program, and the controller can be configured to operate the motor based on a user selection of the one or more user selectable buttons. In certain embodiments, the user interface can include one or more of a depressible button, a switch, or a touchscreen.

In embodiments, the first set of blades and the second set of blades can be operatively connected together such that the first set of blades and the second set of blades rotate together and at the same speed. In embodiments, the first set of blades can include a first pair of arcuate blades extending radially outward from a rotational axis of the first set of blades, oriented substantially parallel to a horizontal plane defined perpendicular to the rotational axis. The first pair of arcuate blades can from an “S” shape, resembling that of conventional food processor blades. In certain embodiments, a leading edge of the arcuate blade can be serrated and a trailing edge of the arcuate blade can be smooth. In certain embodiments, the first set of blades can further include a second pair of arcuate blades parallel to the horizontal plane and circumferentially offset from the first pair of arcuate blades about the rotational axis. The second pair of arcuate blades can form a second “S” shape.

In embodiments, the second set of blades can include two or more pointed blades extending radially outward from the rotational axis and extending away from the base at an angle between the horizontal plane and the rotational axis, similar to conventional blender blades. In certain embodiments, the two or more pointed blades can include four pointed blades, arranged in pairs circumferentially offset from one another, and circumferentially offset from the first set of blades about the rotational axis. In embodiments, the second set of blades can be radially shorter than the first set of blades.

In embodiments, the container can include a first container portion extending axially from a base portion of the container to a container transition point to define a generally cylindrical shape, and a second container portion extending in an axial direction from the container transition portion to a lid portion of the container to define a generally frustoconical shape. In embodiments, the container can include one or more ribs defined on an inner diameter of the container extending radially inward into the container configured to induce turbulent and/or vortical flow of the foodstuffs within the container. The one or more ribs can each include a first rib portion having a first shape and extending from the container transition portion to a rib transition portion and a second rib portion having a second shape, different from the first shape, and extending from the rib transition portion to a location proximate a lid end of the container. The first rib portion can be configured to force the foodstuffs upward towards the second rib portion such that the foodstuffs transitions from the first container portion to the second container portion for blending by the second set of blades subsequent processing by the first set of blades.

In embodiments, the first set of blades can be contained entirely within the first container portion such that a plane defined by at least one blade of the first set of blades intersects the first container portion in a direction radially outward from the rotational axis, and the second set of blades can extend from the first container portion into the second container portion,

The system can further include the motor, a handle extending radially outward from the container, a dispenser unit fluidly connected to an interiors of the container configured to dispense the foodstuffs from the container without disassembling the container from the base, a lid, and a spout defined in the lid portion of the container. The base portion of the container can include a thread for coupling the container to a corresponding thread in the base.

In embodiments, the base can also include an electrical connection means configured to provide electrical power from an external power source to one or more electrical components of the system. The one or more electrical components can include the motor, the controller, a user interface and one or more indicators on the user interface.

In accordance with at least one aspect of this disclosure, a control system for a blender can include a controller operatively connected to control a motor to drive a set of blades about a rotational axis at a first speed for a first predetermined time interval and at a second speed, different from the first speed, for a second predetermined time interval subsequent expiration of the first time interval. The controller can be configured to automatically switch between the first speed and the second speed based on a predefined program selected by a user.

The predefined program can include a respective type of foodstuff, a respective type of preparation for a the respective type of foodstuff, and a respective timing sequence for the respective type of preparation. The respective timing sequence can include a first time interval for operation of the blades at the first speed to process the foodstuffs and a second time interval for operation of the blades at the second speed subsequent to completion of the first time interval to blend the foodstuffs.

In accordance with at least one aspect of this disclosure, a blade system for a blender can be configured to be driven by a motor controlled by the control system described hereinabove. The blade system can include a first set of blades having a first shape configured and adapted to process foodstuffs within the container at a first speed and a second set of blades operatively connected to the first set of blades having a second shape configured and adapted to blend the foodstuffs within the container at a second speed subsequent to processing by the first set of blades. The first and second set of blades can include any embodiment of blades as described herein.

In accordance with at least one aspect of this disclosure, a blender container can be configured to be operatively coupled to a base assembly having the blade system as described hereinabove. In embodiments, the blender container can include a first container portion extending axially from a base portion of the container to a container transition point to define a generally cylindrical shape, and a second container portion extending in an axial direction from the container transition portion to a lid portion of the container to define a generally frustoconical shape. One or more ribs can be defined on an inner diameter of the container extending radially inward into the container configured to induce turbulent and/or vortical flow of the foodstuffs within the container, the ribs including a first rib portion extending from the container transition portion to a rib transition portion and a second rib portion extending from the rib transition portion to a location proximate a lid portion of the container. The first rib portion can be configured to force the foodstuffs upward towards the second rib portion such that the foodstuffs transitions from the first container portion to the second container portion for blending by a second set of blades subsequent processing by a first set of blades.

In accordance with at least one aspect of this disclosure, a blender can include a base and a container, the base configured to be operatively coupled to the container.

The base can include a first set of blades having a first shape configured and adapted to process foodstuffs within the container and a second set of blades operatively connected to the first set of blades having a second shape configured and adapted to blend the foodstuffs within the container. The base can include a user interface having one or more user selectable buttons corresponding to a respective predefined program. The base can also include a controller operatively connected to control a motor to drive a set of blades about a rotational axis at a first speed for a first predetermined time interval and at a second speed, different from the first speed, for a second predetermined time interval subsequent expiration of the first time interval. The controller can be configured to automatically switch between the first speed and the second speed based on the predefined program selected by the user.

The container can be configured to hold foodstuffs and can be configured to be removeably coupled to the base. The container can include a first container portion extending axially from a base portion of the container to a container transition point to define a generally cylindrical shape, and a second container portion extending in an axial direction from the container transition portion to a lid portion of the container to define a generally frustoconical shape. The container can include one or more ribs defined on an inner diameter of the container extending radially inward into the container configured to induce turbulent and/or vortical flow of the foodstuffs within the container, the ribs including a first rib portion extending from the container transition portion to a rib transition portion and a second rib portion extending from the rib transition portion to a location proximate a lid portion of the container.

The first rib portion can be configured to force the foodstuffs upward towards the second rib portion such that the foodstuffs transitions from the first container portion to the second container portion for blending by a second set of blades subsequent processing by a first set of blades. These and other features of the embodiments of the subject disclosure will become more readily apparent to those skilled in the art from the following detailed description taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, embodiments thereof will be described in detail herein below with reference to certain figures, wherein:

FIG. 1 is a perspective view of an embodiment of a system in accordance with this disclosure, showing a blender;

FIGS. 2 and 3 are cross-sectional views of the system of FIG. 1, showing one or more internal components of the system, e.g., a container portion and a first and second set of blades;

FIG. 4 is a top down view of an embodiment of the first set of blades of FIGS. 2 and 3; and

FIG. 5 is a top down view of an embodiment of the second set of blades of FIGS. 2 and 3.

### DETAILED DESCRIPTION

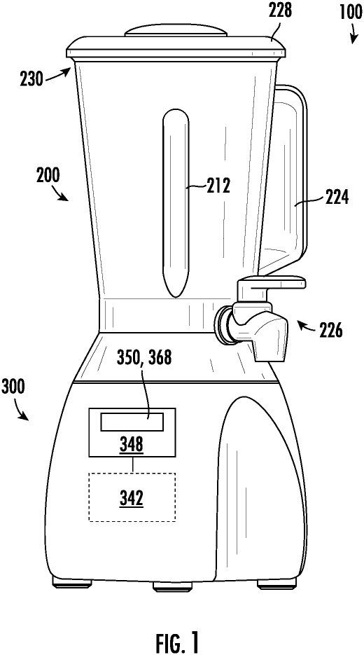

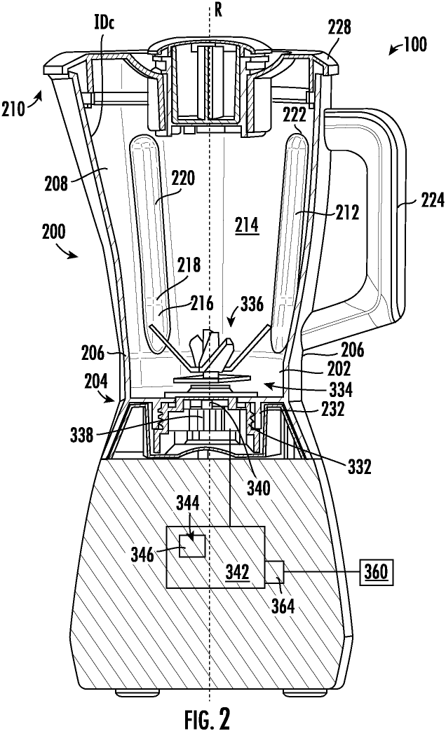

Reference will now be made to the drawings wherein like reference numerals identify similar structural features or aspects of the subject disclosure. For purposes of explanation and illustration, and not limitation, an illustrative view of an embodiment of a system in accordance with the disclosure is shown in FIG. 1 and is designated generally by reference character 100. Other embodiments and/or aspects of this disclosure are shown in FIGS. 2-4.

With reference to FIGS. 1 and 2, in accordance with at least one aspect of this disclosure, a system 100 (e.g., a blender system) includes a container 200 configured to hold foodstuffs and a base 300, the container 200 and base 300 configured to be operatively coupled together. In embodiments, the container 200 can include a first container portion 202 extending axially from a base portion 204 of the container 200 to a container transition portion 206 to define a generally cylindrical shape. The container 200 can include a second container portion 208 extending in an axial direction from the container transition portion 208 to a lid portion 210 of the container 200 to define a generally frustoconical shape.

In embodiments, the container 200 can include one or more ribs 212 defined on an inner diameter IDc of the container 200 extending radially inward into an inner volume 214 the container 200 configured to induce turbulent and/or vortical flow of the foodstuffs within the inner volume 214 of the container 200. The one or more ribs 212 can each include a first rib portion 216 having a first shape and extending from the container transition portion 206 to a rib transition portion 218 and a second rib portion 220 having a second shape, different from the first shape. The second rib portion 220 can extend from the rib transition portion 218 to a location 222 proximate the lid portion 210 of the container 200. The first rib portion 216 can be configured and adapted to force the foodstuffs upward towards the second rib portion 220 such that the foodstuffs transitions from the first container portion 202 to the second container portion 208 when the blender is operational, as discussed further below.

The container can further include a handle 224 extending radially outward from the container 200 and a dispenser unit 226 (e.g., a push-and-dispense release) fluidly connected to the inner volume 214 of the container 200 configured to dispense the foodstuffs from the container 200 without disassembling the container 200 from the base 300. The container 200 can also include a lid 228, and a spout 230 defined in the lid portion 210 of the container 200 for pouring the foodstuffs from the container 200. The base portion 204 of the container 200 can include a coupling 232, (e.g., a thread), configured to engage with a complimentary coupling on the base 300.

In embodiments, the base 300 can include a coupling 332 (e.g., a thread) configured to interact with a complimentary coupling 232 on the container 200. The base 300 can include at least a first set of blades 334 having a first shape configured and adapted to process foodstuffs within the container 200 and at least a second set of blades 336 operatively connected to the first set of blades 334 having a second shape configured and adapted to blend the foodstuffs within the container 200. Embodiments can include two or more sets of blades (e.g., three sets, four sets, or more), each set including blades similar or different from one another within each blade set, or with respect to the other blade sets. A motor 338 can be included in the base 300 to drive the first set of blades 334 and the second set of blades 336 about a rotational axis R. The motor 338 can operatively connected to the first and second set of blades 334, 336 via a drive shaft 340. The first set of blades 334 and the second set of blades 336 can be operatively connected together on the shaft 340 such that they rotate together and at the same speed relative to one another. In other words, the first and second sets of blades 334, 336 rotate at the first speed together, rotate at the second speed together, and change speeds together.

The base 300 can include control circuitry 342, for example on a printed circuit board having a controller 344 operatively connected thereto or thereon. The controller 344 can be or include a motor controller configured to automatically switch the motor 338 between a first speed and a second speed based on a predefined program selected by a user, and without user intervention to change the speed. In embodiments, the first speed is slower (e.g., adapted for processing foodstuffs) than the second speed (e.g., adapted for blending foodstuffs).

The controller 344 can include a memory 346, the memory 346 configured to store the predefined program. In embodiments, the predefined program can include, a respective type of foodstuff, a respective type of preparation for the respective type of foodstuff, and a respective timing sequence for the respective type of preparation. The respective timing sequence can include a first time interval for operation of the blades 344, 346 at the first speed to process the foodstuffs (e.g., as a food processor) and a second time interval for operation of the blades 334, 336 at the second speed subsequent to completion of the first time interval to blend the foodstuffs (e.g., as a blender or mixer). Processing the foodstuff can include at least one of crushing or chopping relatively large pieces of foodstuff and blending the foodstuffs can include at least one of stirring, pureeing, or mixing relatively small pieces of foodstuffs (e.g., smaller than the large pieces). A third time interval can be defined for operating the motor at a third speed, which can be faster than the first speed and the second speed.

As an example, one type of foodstuff can be a mixed drink having multiple liquid and solid ingredients and one type of preparation can be a frozen preparation. If this foodstuff and preparation is selected by the user, the respective timing sequence will operate the motor 338 to drive the blades 334, 336 at the first speed (e.g., about 6,000 rpm) for the first time interval (e.g., about 20 seconds) to break up the large pieces of solid ingredients, which may include ice or large pieces of fruit, for example. Once the first time interval has expired, the controller 344 can automatically control the motor 338 to switch to the second speed (e.g., about 10,000 rpm), to break up the processed ingredients into smaller pieces and blend the solid ingredients with the liquid ingredients for the second time interval (e.g., about 30 seconds). Then, if included, the controller 334 can automatically control the motor 338 to switch to the third speed (e.g., about 22,000 rpm) to mix the ingredients to a final texture for a third time interval (e.g., about 30 seconds). One or more stop intervals can also be included in the program, for example between each of the defined time intervals. For example, the stop intervals can cause the controller 334 to pause rotation of the motor 338 for the defined stop interval (e.g., about 5 seconds) to allow the ingredients to settle between the first, second, and/or third time intervals.

The respective time and stop intervals as discussed above are for explanation and illustration purposes, and are non-limiting. The time and stop intervals can be different and specific to each predefined program, based on the different preparations. For example based on whether large or small ingredients are included and whether liquid or solid ingredients are included. Large, hard, solid ingredients, or dry ingredients being broken down into a smooth preparation may have longer time intervals at the first speed and shorter time intervals at the second speed as opposed to all liquid ingredients, for example, which may have a very short or no time interval at the first speed and longer time intervals at the second speed. Certain preparations may cycle through each time interval multiple times, with a stop interval between each. At the end of the predefined program, the controller 334 can issue a notification (e.g., audible or visual indication) to the user through a user interface 348 that the program is complete and the foodstuffs is ready for consumption and/or dispensing.

Still with reference to FIGS. 1 and 2, in embodiments, the base 300 can include a user interface 348 having one or more user selectable buttons 350 corresponding to a respective predefined program (e.g., frozen drink as described in the example above). The user interface 348 can be operatively connected to the control circuitry 342 to provide user input to the controller 344 and to provide feedback to the user. The controller 344 can be configured to operate the motor 338 based on a user selection (e.g., the user input) of the one or more user selectable buttons 350. In certain embodiments, the user selectable buttons 350 can include one or more of a depressible button, a switch, a touchscreen, or the like.

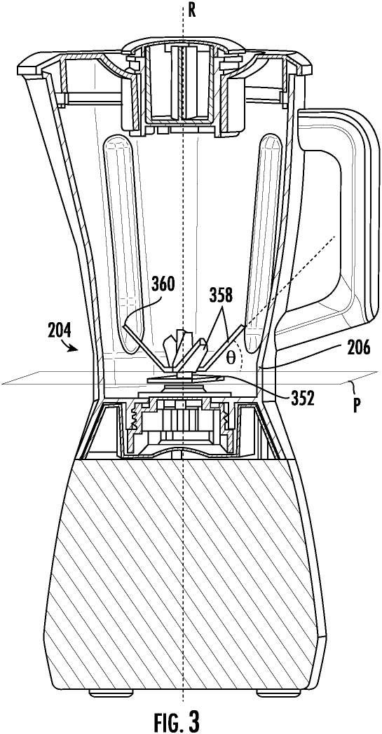

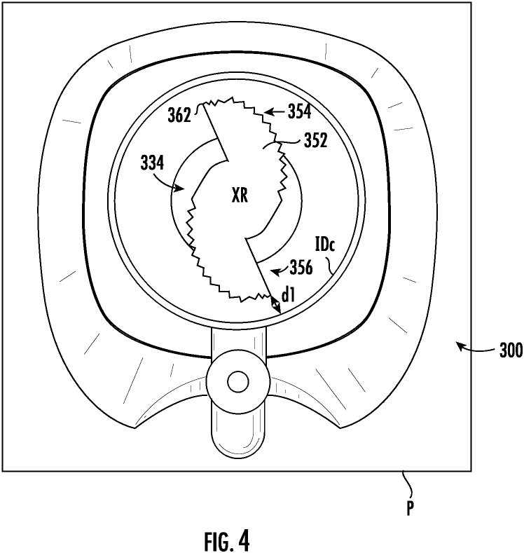

Referring now to FIGS. 3-5, in embodiments, the first set of blades 334 can include a first pair of arcuate blades 352 extending radially outward from the rotational axis R of the first set of blades, oriented substantially parallel to a horizontal plane P defined perpendicular to the rotational axis R. The first pair of arcuate blades 352 can from an “S” shape, resembling that of conventional food processor blades, for example. In certain embodiments, a leading edge 354 of the arcuate blade can be serrated and a trailing edge 356 of the arcuate blade can be smooth, as best seen in FIG. 4. In certain embodiments, the first set of blades 334 can further include a second pair of arcuate blades parallel to the horizontal plane P and circumferentially offset from the first pair of arcuate blades 352 about the rotational axis R. The second pair of arcuate blades can form a second “S” shape.

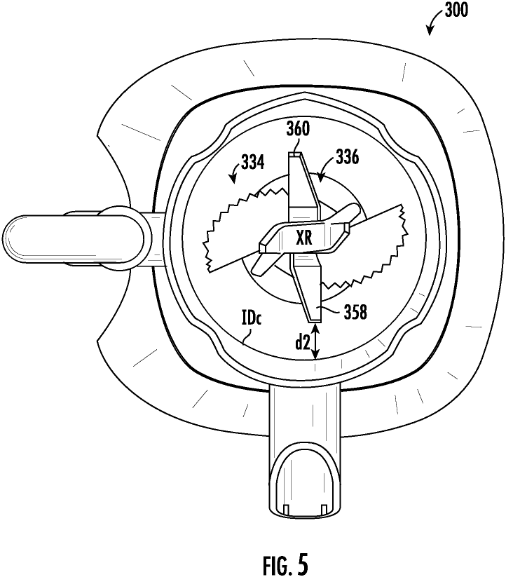

In embodiments, the second set of blades 336 can include two or more pointed blades 358 extending radially outward from the rotational axis and extending away from the base 300 at an angle θ between the horizontal plane P and the rotational axis R, similar to conventional blender blades for example, as best seen in FIG. 3. In certain embodiments, the two or more pointed blades 358 can include four pointed blades (e.g., as shown), arranged in pairs circumferentially offset from one another, and circumferentially offset from the first set of blades 334 about the rotational axis R, as best seen in FIG. 5. In embodiments, each set of blades can include between 2 and 8 blades. In embodiments, the total number of blades can be between 4 to 8 blades. In certain embodiments, the total number of blades can be 6 blades, for example.

In embodiments, the first set of blades 334 can be contained entirely within the first container portion 202 such that a plane defined by at least one blade 352 of the first set of blades 334 intersects the first container portion 202 in a direction radially outward from the rotational axis R. In other words, no portion of the first set of blades 334 extends beyond the container transition portion 206 into the second container portion 208. This can be seen most clearly in FIG. 3. The second set of blades 336 can extend from within the first container portion 202 into the second container portion 208 such that a tip 360 of at least one blade 358 reaches above the container transition portion 206. A tip 362 of at least one blade 352 of the first set of blades 334 extends radially beyond the tip 360 of the blades 358 such that a distance d1 from the tip 362 to the inner diameter IDc of the container 200 is smaller than a distance d2 from the tip 360 to the inner diameter IDc of the container 200.

This configuration allows the first rib portion 216 to urge the foodstuffs upward from the first container portion 202 towards the second rib portion 220 and the second container portion 208 such that the foodstuffs transitions from being processed within the first container portion 202 to being blended in the second container portion 208. Said differently, the combination of the first and second set of blades 334, 336 along with their relative positions with respect to the first and second container portions 202, 208 and the first and second rib portions 216, 220, allows the foodstuffs to remain in the first container portion 202 with the first set of blades 334 while the larger, more solid foodstuffs are broken down, before being moved upwards into the second container portion 208 for blending by the second set of blades 336.

In embodiments, the base 300 can also include an electrical connection means 364 configured to provide electrical power from an external power source 366 to one or more electrical components of the system, e.g., as shown in FIGS. 1 and 2. The one or more electrical components can include the motor 338, the control circuitry 342, the controller 344, the user interface 348 and one or more indicators on the user interface 368 (e.g., LEDs). In certain embodiments, the container can be configured for use as a to-go tumbler.

As will be appreciated by those skilled in the art, aspects of the present disclosure may be embodied as a system, method or computer program product. Accordingly, aspects of this disclosure may take the form of an entirely hardware embodiment, an entirely software embodiment (including firmware, resident software, micro-code, etc.), or an embodiment combining software and hardware aspects, all possibilities of which can be referred to herein as a “circuit,” “module,” or “controller.” A “circuit,” “module,” or “controller” can include one or more portions of one or more separate physical hardware and/or software components that can together perform the disclosed function of the “circuit,” “module,” or “controller”, or a “circuit,” “module,” or “controller” can be a single self-contained unit (e.g., of hardware and/or software). Furthermore, aspects of this disclosure may take the form of a computer program product embodied in one or more computer readable medium(s) having computer readable program code embodied thereon.

Those having ordinary skill in the art understand that any numerical values disclosed herein can be exact values or can be values within a range. Further, any terms of approximation (e.g., “about”, “approximately”, “around”) used in this disclosure can mean the stated value within a range. For example, in certain embodiments, the range can be within (plus or minus) 20%, or within 10%, or within 5%, or within 2%, or within any other suitable percentage or number as appreciated by those having ordinary skill in the art (e.g., for known tolerance limits or error ranges).

The articles “a”, “an”, and “the” as used herein and in the appended claims are used herein to refer to one or to more than one (i.e., to at least one) of the grammatical object of the article unless the context clearly indicates otherwise. By way of example, “an element” means one element or more than one element.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.”

Any suitable combination(s) of any disclosed embodiments and/or any suitable portion(s) thereof are contemplated herein as appreciated by those having ordinary skill in the art in view of this disclosure.

The embodiments of the present disclosure, as described above and shown in the drawings, provide for improvement in the art to which they pertain. While the apparatus and methods of the subject disclosure have been shown and described, those skilled in the art will readily appreciate that changes and/or modifications may be made thereto without departing from the scope of the subject disclosure.

What is claimed is:

1. A system comprising:
a container configured to hold foodstuffs;
a base configured to be operatively coupled to the container, wherein the base includes:
two or more sets of blades, the two or more sets of blades including:
a first set of blades having a first shape configured and adapted to process foodstuffs within the container;
a second set of blades operatively connected to the first set of blades having a second shape configured and adapted to blend the foodstuffs within the container; and
a controller operatively connected to control a motor to drive the first set of blades and the second set of blades about a rotational axis, the controller configured to automatically switch between at least a first speed and a second speed based on a predefined program selected by a user.

2. The system of claim 1, wherein the controller includes a memory, the memory configured to store the predefined program.

3. The system of claim 1, wherein the predefined program includes:
a respective type of foodstuff;
a respective type of preparation for a the respective type of foodstuff; and
a respective timing sequence for the respective type of preparation.

4. The system of claim 3, wherein the respective timing sequence includes a first time interval for operation of the blades at the first speed to process the foodstuffs, a second time interval for operation of the blades at the second speed subsequent to completion of the first time interval to blend the foodstuffs, and a third time interval for operation of the blades at either the first speed, the second speed, or a third speed subsequent to completion of the second time interval to complete preparation of the foodstuffs.

5. The system of claim 4, wherein the controller is configured to control the motor to cycle the blades through a series of the first time interval, the second time interval, and the third time interval based on the predefined program, wherein an order of the first time interval, the second time interval, and the third time interval in the timing sequence and a number of cycles is defined by the predefined program.

6. The system of claim 1, wherein the first set of blades and the second set of blades are operatively connected such that the first set of blades and the second set of blades rotate together and at the same speed.

7. The system of claim 1, wherein the first set of blades includes a first pair of arcuate blades extending radially outward from a rotational axis of the first set of blades, oriented substantially parallel to a horizontal plane defined perpendicular to the rotational axis.

8. The system of claim 7, wherein the second set of blades includes two or more pointed blades extending radially outward from the rotational axis and extending away from the base at an angle between the horizontal plane and the rotational axis.

9. The system of claim 1, wherein the container includes a first container portion extending axially from a base portion of the container to a container transition point to define a generally cylindrical shape, and a second container portion extending in an axial direction from the container transition portion to a lid portion of the container to define a generally frustoconical shape.

10. The system of claim 9, wherein the container includes one or more ribs defined on an inner diameter of the container extending radially inward into the container configured to induce turbulent and/or vortical flow of the foodstuffs within the container, the one or more ribs including a first rib portion having a first shape and extending from the container transition portion to a rib transition portion and a second rib portion having a second shape, different from the first shape, and extending from the rib transition portion to a location proximate a lid portion of the container.

11. The system of claim 10, wherein the first rib portion is configured to force the foodstuffs upward towards the second rib portion such that the foodstuffs transitions from the first container portion to the second container portion for blending by the second set of blades subsequent processing by the first set of blades.

12. The system of claim 9, wherein the first set of blades is contained entirely within the first container portion, and wherein the second set of blades extends from the first container portion into the second container portion.

13. A control system for a blender, comprising,
a controller operatively connected to control a motor to drive a set of blades about a rotational axis at a first speed for a first predetermined time interval and at a second speed, different from the first speed, for a second predetermined time interval subsequent expiration of the first time interval, wherein the controller is configured to automatically switch between the first speed and the second speed based on a predefined program selected by a user.

14. The control system of claim 13, wherein the predefined program includes:
a respective type of foodstuff;
a respective type of preparation for a the respective type of foodstuff; and
a respective timing sequence for the respective type of preparation.

15. The control system of claim 14, wherein the respective timing sequence includes a first time interval for operation of the blades at the first speed to process the foodstuffs, a second time interval for operation of the blades at the second speed subsequent to completion of the first time interval to blend the foodstuffs, and a third time interval for operation of the blades at either the first speed, the second speed, or a third speed subsequent to completion of the second time interval to complete preparation of the foodstuffs.

16. A blade system for a blender, the blade system configured to be driven by a motor controlled by the control system of claim 13, wherein the blade system includes, at least:
a first set of blades having a first shape configured and adapted to process foodstuffs within the container at a first speed;
a second set of blades operatively connected to the first set of blades having a second shape configured and adapted to blend the foodstuffs within the container at a second speed subsequent to processing by the first set of blades.

17. The blade system of claim 16, wherein the first set of blades includes a first pair of arcuate blades extending radially outward from a rotational axis of the first set of blades, oriented substantially parallel to a horizontal plane defined perpendicular to the rotational axis, and wherein the second set of blades includes two or more pointed blades extending radially outward from the rotational axis and extending away from the base at an angle between the horizontal plane and the rotational axis.

18. A blender container configured to be operatively coupled to a base assembly having the blade system of claim 16, the blender container comprising:
a first container portion extending axially from a base portion of the container to a container transition point to define a generally cylindrical shape, and a second container portion extending in an axial direction from the container transition portion to a lid portion of the container to define a generally frustoconical shape;
one or more ribs defined on an inner diameter of the container extending radially inward into the container configured to induce turbulent and/or vortical flow of the foodstuffs within the container, the ribs including a first rib portion extending from the container transition portion to a rib transition portion and a second rib portion extending from the rib transition portion to a location proximate a lid portion of the container,
wherein the first rib portion is configured to force the foodstuffs upward towards the second rib portion such that the foodstuffs transitions from the first container portion to the second container portion for blending by a second set of blades subsequent processing by a first set of blades.

19. The blender container of claim 18, wherein the first set of blades is contained entirely within the first container portion, and wherein the second set of blades extends from the first container portion into the second container portion.

20. A blender, comprising:
a container configured to hold foodstuffs, the container comprising:
a first container portion extending axially from a base portion of the container to a container transition point to define a generally cylindrical shape, and a second container portion extending in an axial direction from the container transition portion to a lid portion of the container to define a generally frustoconical shape;
one or more ribs defined on an inner diameter of the container extending radially inward into the container configured to induce turbulent and/or vortical flow of the foodstuffs within the container, the ribs including a first rib portion extending from the container transition portion to a rib transition portion and a second rib portion extending from the rib transition portion to a location proximate a lid portion of the container,
wherein the first rib portion is configured to force foodstuffs upward towards the second rib portion such that the foodstuffs transition from the first container portion to the second container portion.
